(19) United States
(12) Patent Application Publication
(10) Pub. No.: US 2019/0189034 A1
(43) Pub. Date: Jun. 20, 2019

(54) TAMPER RESISTANT CABLE LOCK

(71) Applicant: Gregory Kleynerman, Fox Point, WI (US)

(72) Inventor: Gregory Kleynerman, Fox Point, WI (US)

(21) Appl. No.: 16/275,725

(22) Filed: Feb. 14, 2019

Related U.S. Application Data
(63) Continuation of application No. 14/688,479, filed on Apr. 16, 2015.

(51) Int. Cl. G09F 3/03; E05B 39/02

(52) U.S. Cl. CPC G09F 3/0352; E05B 39/02

(57) ABSTRACT

A cable lock and cable, the lock comprising a body adapted to secure at least one end of a cable therein, the body having a side, and a body opening in the body side and receiving another end of the cable. The lock also includes a boss on the body side, the boss being spaced apart from the body opening and having a cable passing there through.

### CROSS-REFERENCE TO RELATED APPLICATIONS

This is a continuation of prior application Ser. No. 14/688,479 filed Apr. 16, 2015.

### BACKGROUND

This disclosure relates to a cable lock for a variety of uses. In particular, this disclosure relates to a cable lock with tamper resistant features.

Cable locks are used for a variety of purposes. One use is to lock a device such as a shipping container or a water meter. The cable is inserted through the hasp of the container or meter and then locked in place with a cable lock that cannot release the cable without breaking the lock or cable. The only way to release the cable lock once the cable is inserted into the channel of a gripping mechanism is to cut the cable. This arrangement prevents tampering, because tampering is easily detected by the presence of the broken or damaged cable or lock. A cable lock of this type is shown in U.S. Pat. No. 6,131,969.

While the locking mechanism of the cable lock serves to lock cables in place, many of them can still be tampered with. If the cable is replaced in such a fashion that it no longer looks like the cable has been severed, tamper evidence is hidden. For example, if the cable end adjacent the device is severed and then glued back in place, or replaced with another cable, it is hard to recognize that the cable lock has been tampered with.

### SUMMARY

Disclosed is a cable lock and cable, the lock comprising a body adapted to secure at least one end of a cable therein, the body having a side, and a body opening in the body side and receiving another end of the cable. The lock also includes a boss on the body side, the boss being spaced apart from the body opening and having a cable passing there through.

This disclosure provides a cable lock that is ore tamper resistant than conventional cable locks.

### BRIEF DESCRIPTION OF THE DRAWINGS

FIG. 1 is a side perspective view of a cable lock shell.

FIG. 2 is a perspective view of another side of the cable lock shell of FIG.

FIG. 3 is a top view of the cable lock shell of FIG. 1.

FIG. 4 is a side view of the cable lock shell of FIG. 1.

FIG. 5 is an end view of the cable lock shell on FIG. 1.

FIG. 6 is a schematic bottom view of a cable lock according to this disclosure.

FIG. 7 is a side perspective view of a cable lock and cable according to this disclosure.

FIG. 8 is a perspective bottom view of a cable lock and cable according to this disclosure.

Before one embodiment of the disclosure is explained in detail, it is to be understood that the disclosure is not limited in its application to the details of the construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward”, “downward”, “side”, “top” and “bottom”, etc., are words of convenience and are not to be construed as limiting terms.

### DESCRIPTION OF THE EMBODIMENT

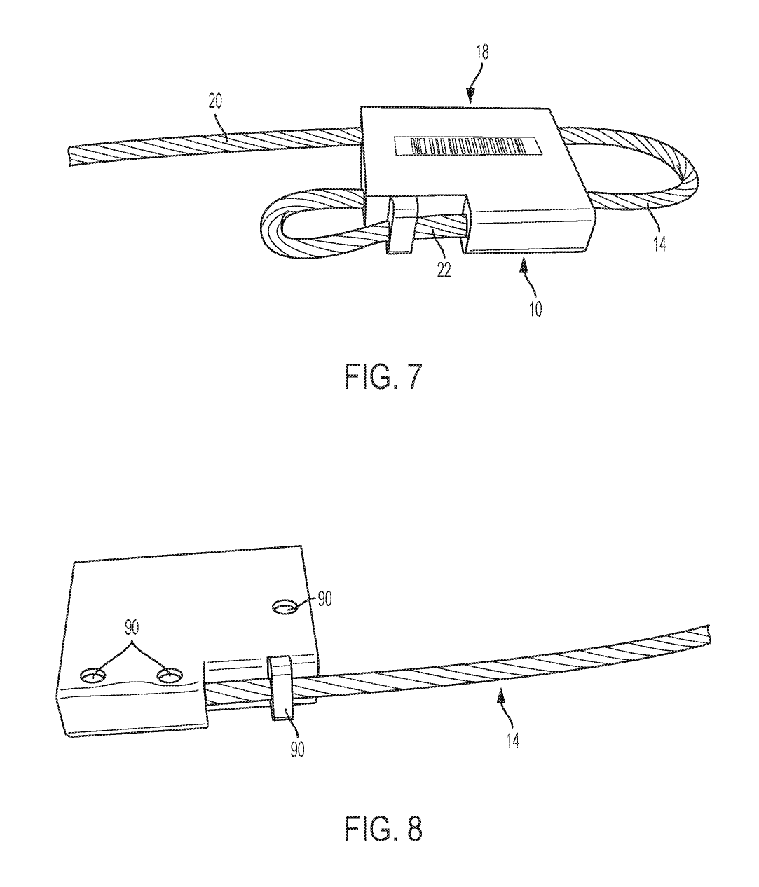

Referring now in detail to the drawings, shown in FIG. 7 is a cable lock 10 adapted to be used with a cable 14. The cable 14 is formed of a helix of a number of twisted strands, each strand having a predetermined pitch and each of these strands consisting of an equal number of twisted strands. But in other embodiments (not shown), other types of wires or cables can be used.

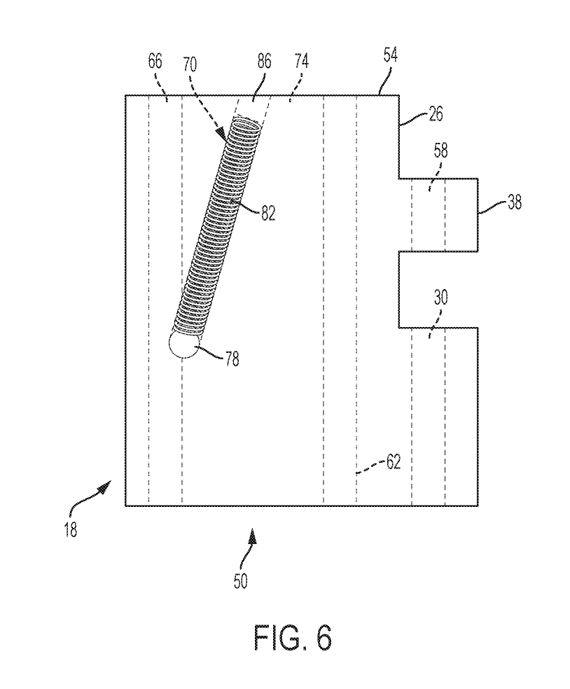

As shown schematically in FIG. 6, the cable lock 10 comprises a body 18 adapted to secure at least one end 20 of the cable 14 therein, the body 18 having a side 26 and a body opening 30 in the body side 26 adapted to receive another end 22 of the cable 14, and a boss 38 on the body side 26, the boss 38 being spaced apart from the body opening 30 and having a cable passageway 58 there through. More particularly, the body opening 30 is a through hole. But in other embodiments (not shown), the body opening can be a blind hole with a rear wall. Still more particularly, as illustrated in the drawings, the body side is stepped, with a step having an upper step portion, a vertical face, and a lower step portion. In the disclosed embodiment, the upper step portion is parallel to the lower step portion. The body opening 30 extends through the step and extends parallel to the vertical face.

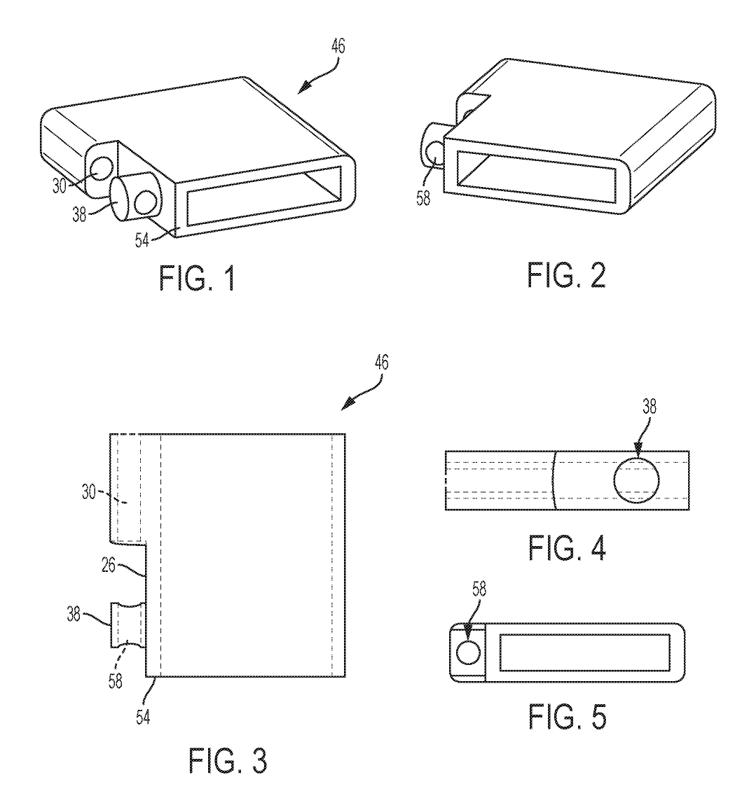

More particularly, the body 18 includes a cable lock shell 46, as illustrated in FIGS. 1 to 5, and a mechanism 50 (see FIG. 6) for securing the at least one end of a cable 14 therein. The cable lock shell 46 is adapted to receive the mechanism 50. More particularly, the cable lock shell 46 is in the form of a sleeve that surrounds the mechanism 50. In the disclosed embodiment, the shell 46 is rectangular and malleable, such as being made of an aluminum alloy.

The boss 38 is generally cylindrical, but in other embodiments, such as shown in FIGS. 7 and 8, other boss shapes, such as a box shape, can be used. The boss 38 is integral with the remainder of the body 18, but in other embodiments (not shown), the boss can be attached to the remainder of the body.

In the illustrated embodiment, as shown in FIG. 6, the body side has a straight lower portion, and the straight lower portion has an outer edge 54 adjacent the boss 38 at the end of the body side 26. In the disclosed embodiment, the outer edge 54 is spaced apart from the boss 38. The boss passageway 58 is coaxial with the body opening 30, and parallel to the lower portion. In other embodiments (not shown), other body shapes, including shapes with curved sides, can be used.

The mechanism 50, shown schematically in FIG. 6, has two passageways there through. In other embodiments (not shown), more or less passageways can be present, depending on the intended use of the cable lock. One passageway 62 is intended to allow a cable end to pass there through, and a second passageway 66, spaced apart from and parallel to the first, 62 is intended to receive and secure the end of a cable. To this end, a third passageway 70 is angled relative to and in communication with the second passageway 66, and extends to the end 74 of the mechanism 50. Received within the third passageway 70 is a ball 78, positioned adjacent the second passageway 66, and a spring 82 that extends between the ball 78 and the end 74 of the mechanism. A plug 86 is placed into the third passageway 70, retaining the ball 78 and spring 82 in place in the third passageway 70.

When an end of a cable is passed into the second passageway 66 from an opposite end of the mechanism, the cable 14 pushes the ball 78 aside, against the bias of the spring 82. This allows the cable 14 to be inserted into the second passageway 66. But when trying to remove the cable from the passageway 66, the spring 82 presses the ball 78 into the side of the cable 14, securing the cable 14 inside the mechanism 50. In other embodiments (not shown), other means of securing the cable inside the mechanism can be used.

In use, the mechanism 50 is placed inside the cable lock shell 46, and the end 22 of the cable 14 is passed through the boss 38 and into the body opening 30. The shell is then indented or swaged 90 as shown in FIG. 8, so that the mechanism 50 and the cable 14 cannot be readily removed from the shell 46, and the boss 38 is swaged or otherwise deformed so the cable 14 is held inside the boss 38. This is how the cable 14 and the cable lock 10 are then supplied to a cable lock user, as shown in FIG. 8.

When the cable lock 10 is used, the other free end 20 of the cable 14 is then passed through the items intended to be secured by the cable, such as shipping door handles. then passed through one end of the mechanism 50 and through the first passageway 62, and then out of the other end of the mechanism 50. The free end of the cable is then passed back into and optionally through the second passageway, where the cable is secured in place inside the mechanism by the ball 78 and spring 82, as shown in FIG. 7.

The spacing of the boss 38 from the body opening 30 and from the straight side outer edge 54 is significant, for the following reasons. If one were to attempt to sever and then glue or otherwise replace a cable end back into the body opening 30, if no boss 38 were present, this would not be too difficult, even if the cable shell 46 was swaged near the opening 30 to the body, for the body mass prevents significant distortion of the entrance to the opening 30. The boss 38, on the other hand, can be distorted by swaging, given its lesser mass. This results in a distortion of the boss 38 that prevents the ready reinsertion of the cable end into the boss 38. The most common method of tampering with the cable lock involves an attempt to drill out a portion of the old cable, and then to replace it. With the small mass of the boss 38, any attempt to drill through the boss 38 is likely to distort and damage the boss 38. In other words, the boss 38 is frangible. As a result, it will be readily apparent if anyone has attempted to drill through the boss 38, for damage to the boss 38 will be evident. And making the boss 38 spaced apart from the end of the body edge 54 discourages the ready severing of the cable 14 near the boss 38.

Various other features of this disclosure are set forth in the following claims.

1-20. (canceled)

21. A method of holding a cable in-a cable lock, the method comprising the steps of:
having a boss on a side of a cable lock so that the boss is located outside of the cable lock and is with attached to the side of the cable lock, the boss having a boss cable receiving passageway in the boss,
passing a portion of a cable through the boss, and then
swaging or otherwise deforming the boss so that the portion of the cable inside the boss is held inside the boss, the mass and the deforming of the boss making the boss frangible, so that an attempt to drill out a portion of the cable in the boss results in visible damage to the boss.
